(19) United States
(12) Patent Application Publication
(10) Pub. No.: US 2025/0188551 A1
(43) Pub. Date: Jun. 12, 2025

(54) PROCESS FOR LIMING OF HIDES, SKINS OR PELTS

(71) Applicant: StahI International B.V., Waalwijk (NL)

(72) Inventor: Andreas Gerardus Josephus Maria VAN DER HAM, 's-Hertogenbosch (NL)

(21) Appl. No.: 18/840,976

(22) PCT Filed: Feb. 24, 2023
(86) PCT No.: PCT/NL2023/050093

§ 371 Date: Aug. 23, 2024

(30) Foreign Application Priority Data
Feb. 25, 2022 (NL) 2031083

(51) Int. Cl. C14C 1/06

(52) U.S. Cl. CPC C14C 1/06

(57) ABSTRACT

The present invention relates to a novel process for liming of skins/hides/pelts using a quaternary ammonium salt as anti-wrinkle agent.

The present invention relates to a novel process for liming skins/hides/pelts to obtain limed skins/hides/pelts of good quality.

It is well known that in the leather manufacturing process, pre-treatments for raw skins/hides/pelts shall be done before tanning and crusting. The leather manufacturing process generally consists of the following steps: soaking (dirt removal and re-hydration); dehairing (removal of hair, traditionally part of the liming process); liming (removal of hair and degradation of fats and proteins as well as swelling of the collagen structure, so called opening up); fleshing (removal of fatty tissue); splitting (horizontal cutting into grain split and flesh split); deliming (releasing lime, degraded proteins/fat and reducing pH); bating (removal of non-structural proteins, scut removal and fibre opening); pickling (lowering of pH value to around 3) and tanning (stabilization of the skin or hide matrix). Beamhouse processes in leathering manufacturing accounts for 80% of organic waste in effluent and sludges. Among these, around 70% comes from the liming process.

During the dehairing step the skins/hides/pelts are normally treated with an alkaline and a sulphide solution which aims at breaking the hair structure at its weakest point, the root of the hairs, by reduction of sulphur-sulphur bonds in the keratin. Besides unhairing, liming is done to constitute controlled damage to the pelt and to the collagen in particular. During the liming step many of the peptide links are broken, but in a controlled way. Non-structural proteins are mostly linear and when a peptide bond is broken then the peptide is broken into fragments, and due to more broken peptide links, the resulting smaller fragments can be easily removed from the hide. In contrast, a broken peptide link within the collagen does not have much effect on the structure, due to its three-dimensional structure. Lime, calcium hydroxide, is normally used as the liming agent. After liming, deliming is required to bring the pH value of pelt to a proper state of alkalinity. Deliming is about removing calcium hydroxide from the skins/hides/pelts, including surfaces and inner parts thereof, and lowering the pH value of skins/hides/pelts until around 8.5 to 7.

Chapter 6 of text book Tanning Chemistry: The Science of Leather by Tony Covington, 2009, ISBN 9780854041701, pages 134-153, describes the process of liming: the purpose and the conditions, such as liming agents, pH, temperature and duration, and the chemical reactions that occur in this liming process and its effect on the crust.

The hide swells during the liming process due to the uptake of salts and water. The swelling is not uniformly distributed over the complete hide, and small differences in skin consistency result in visible wrinkles of the hide after the liming step. The wrinkles are easier visible by a deviation in colour, rather than by height differences in the hide. These wrinkles are most notably visible at the areas of the hide around the neck and the belly and are located there where the hide had the shortest distance to the underlying muscles of the animal. A disadvantage of having such wrinkles is that later on more of the finish/coating on the final leather is needed to camouflage these wrinkles. A disadvantage of the need for more finish on the final leather is that this results in more stiff leather and a less natural touch of the final leather, and in addition needing more finish results in having higher costs, and furthermore, the use of more finishing layer can negatively impact the biodegradability. As an alternative, if more finish is not allowed for the usage of the final leather, then the leather can be cut around the wrinkle areas, but this results in a lower yield of leather, in square meters of leather, from a complete hide. Examples of leather usage, wherein only low amounts of finish are allowed are the fashion industry and leather bags.

An anti-wrinkle agent may be used during the liming process in order to reduce this wrinkle formation. Such anti-wrinkle agents typically consist of primary, secondary, tertiary amines and/or thiols or a mixture thereof. Due to the decay of protein structure of the hide during the liming process there are amines being formed, and adding additional amines or thiols, being antiwrinkle agents, results in a slower swelling of the hides during the liming process, which reduces the formation of wrinkles in the hide.

A disadvantage of using such primary, secondary or tertiary amines and/or thiols or a mixture thereof is that they are generally volatile components, which results in undesired exposure to workers. A further disadvantage is that they are dangerous materials, e.g. they have a chemical classification as being irritant or harmful and/or harmful to the environment, and need to be removed from the tannery effluent, which increases the costs and complexity/duration of wastewater treatment.

There is hence a desire to have suitable anti-wrinkle agents that lack the abovementioned disadvantages.

The object of the present invention is to provide a process for liming skins/hides/pelt that provides skins/hides/pelts of good quality and notably with less wrinkling.

It is a further object of the present invention to provide anti-wrinkle agents for skins/hides/pelts to be used in the liming process, that lead to less waste than the currently used anti-wrinkle agents, that lead to less polluted wastewater, that lead to similar quality of crust and leather and yet are very effective anti-wrinkle agents.

According to the present invention a process for liming of hides, skins or pelts is provided, comprising treating the hides, skins or pelts with a quaternary amine as anti-wrinkle agent generally in an aqueous solution, in combination with a liming agent, in the liming step.

The present invention results in a good quality of crust and good final leather, while the usage of such quaternary amine results in a lower COD (chemical oxygen demand) in the effluent. A further advantage of the use of quaternary amine, compared to the use of industry-standard amines as wrinkling agent, is the possibility of their biobased origin, because there is currently a big driving force for companies and the chemical industry in particular, for corporate responsibility and the use of sustainable or renewable sources of raw materials. Consumers are very interested in products that have been treated with “natural” materials that help to reduce fossil depletion, reduce our carbon dioxide footprint, and are derived from renewable materials.

Quaternary amines are also known as quaternary ammonium salts. They can be represented by the formula X⁽⁻⁾N⁽⁺⁾R₁R₂R₃R₄, wherein R₁, R₂, R₃ and R₄ may be the same or different alkyl or aryl groups, and such alkyl or aryl group may further by functionalized with other groups, such as hydroxyl, carboxyl or halide groups and wherein X⁽⁻⁾ is a negative counterion present in case none of R₁, R₂, R₃ and R₄ in itself represents an internal counterion. The alkyl or aryl groups of R₁, R₂, R₃ and R₄ contain typically between 1 and 18 carbon atoms. Preferably R₁ and R₂ are both alkyl groups with 1 to 4 carbon atoms such as methyl groups or butyl groups. The quaternary amine is permanently charged, independent of pH conditions, and is thus accompanied by a negative counter ion X). The number of examples of quaternary ammonium salts is very large, because of the large variety that is possible in the R₁, R₂, R₃ and R₄ groups and the variety in the counter ions. A selection of such quaternary ammonium salts are the salts of 2-hydroxy-N,N,N-trimethyl-ethanaminium (also known as choline), N,N,N-triethyl-2-hydroxy-ethanaminium, 2-hydroxy-N,N,N-trimethyl-1-propanaminium, 1-hydroxy-N,N,N-trimethyl-1-propanaminium, N,N,N-trimethyl-methanaminium, N,N,N-triethyl-ethanaminium, N,N-diethyl-N-methyl-ethanaminium, N,N,N-trimethyl-1-tetradecanaminium, N,N,N-tributyl-1-butanaminium (also known as tetrabutylammonium), N,N,N-tripropyl-1-propanaminium, N,N,N-trimethyl-1-octanaminium, N,N,N-trimethyl-1-hexanaminium, N,N-dibutyl-N-ethyl-1-butanaminium, N,N,N-trimethyl-1-propanaminium, N-decyl-N,N-dimethyl-1-decanaminium, N-methyl-N,N-dioctyl-1-octanaminium, N,N,N-triethyl-1-octanaminium, N,N, N-trimethyl-2-propanaminium, N,N,N,2-tetramethyl-2-propanaminium, N, N-dibutyl-N-propyl-1-butanaminium, 3-methyl-N,N,N-tris(3-methylbutyl)-1-butanaminium, N-hexadecyl-N,N-dimethyl-1-hexadecanaminium, N-decyl-N,N-dimethyl-1-dodecanaminium, N,N,N-trimethyl-2-butanaminium, N,N-dimethyl-N-propyl-1-propanaminium, N,N,N-trimethyl-1-docosanaminium, N,N,N-tridodecyl-1-dodecanaminium, N,N,N-tris(decyl)-1-decanaminium, N, N,N-trioctadecyl-1-octadecanaminium, N,N,N-trihexadecyl-1-hexadecanaminium, 2-hydroxy-N-(2-hydroxyethyl)-N,N-dimethyl-ethanaminium, N-ethyl-2-hydroxy-N-(2-hydroxyethyl)-N-methyl-ethanaminium, N,N-bis(2-hydroxyethyl)-N-methyl-1-dodecanaminium, N,N-bis(2-hydroxyethyl)-N-methyl-1-octadecanaminium, 1-hydroxy-N,N-bis(hydroxymethyl)-N-methyl-methanaminium, N-ethyl-2-hydroxy-N,N-bis(2-hydroxyethyl)-ethanaminium, N,N,N-tris(hydroxymethyl)-ethanaminium, 2-hydroxy-N,N-bis(2-hydroxyethyl)-N-methyl-ethanaminium, N,N,N-tris(2-hydroxyethyl)-1-octadecanaminium, 2-hydroxy-N,N,N-tris(2-hydroxyethyl)-ethanaminium, 1-hydroxy-N,N,N-tris(hydroxymethyl)-methanaminium, 2-chloro-N,N,N-trimethyl-ethanaminium, 2-bromo-N,N,N-trimethyl-ethanaminium, 2-fluoro-N,N,N-trimethyl-ethanaminium, 3-bromo-N,N,N-trimethyl-1-propanaminium, N-hexadecyl-N,N-dimethyl-benzenemethanaminium, N-dodecyl-N,N-dimethyl-benzenemethanaminium, N,N,N-trimethyl-benzenemethanaminium, N,N-dimethyl-N-tetradecyl-benzenemethanaminium, 2-hydroxy-N,N,N-trimethyl-benzenemethanaminium, N,N-dimethyl-N-octadecyl-benzenemethanaminium, N,N-dimethyl-N-octyl-benzenemethanaminium, N,N-dimethyl-N-tridecyl-benzenemethanaminium, N-decyl-N,N-dimethyl-benzenemethanaminium. Additional examples of quaternary ammonium salts are those that have an internal counterion as one of the groups R₁, R₂, R₃ or R₄, such as a carboxylic group so that the presence of X) is not needed: 1-carboxy-N,N,N-trimethyl-1-undecanaminium, 1-carboxy-N,N,N-trimethyl-1-heptadecanaminium, 1-carboxy-N,N,N-trimethyl-methanaminium (also known as trimethylglycine), 3-carboxy-N,N,N-trimethyl-1-propanaminium, N-(carboxymethyl)-N,N-dimethyl-1-dodecanaminium, 1-N-(carboxymethyl)-N,N-dimethyl-hexadecanaminium, N-(carboxymethyl)-N,N-dimethyl-1-octadecanaminium, N-(carboxymethyl)-N,N-dimethyl-1-tetradecanaminium, N-(carboxymethyl)-N,N-dimethyl-1-decanaminium, N,N-dibutyl-N-(carboxymethyl)-1-butanaminium, 2-carboxy-N,N,N-trimethyl-ethanaminium, 4-carboxy-N,N,N-trimethyl-,1-bButanaminium, 5-carboxy-N,N,N-trimethyl-1-pentanaminium, N-(carboxymethyl)-N-dodecyl-N-methyl-1-dodecanaminium, N-(carboxymethyl)-N,N-diethyl-ethanaminium, N-(carboxymethyl)-N,N-dimethyl-1-docosanaminium, N-(carboxymethyl)-N, N-dimethyl-1-octanaminium, N-(carboxymethyl)-N,N-dimethyl-1-propanaminium, 1-carboxy-N,N,N-trimethyl-ethanaminium, 1-carboxy-N-(carboxymethyl)-N,N-dimethyl-methanaminium, N,N,N-tris(carboxymethyl)-1-dodecanaminium, N-(2-carboxyethyl)-2-hydroxy-N,N-dimethyl-ethanaminium, N-(carboxymethyl)-2-hydroxy-N,N-dimethyl-ethanaminium, 3-carboxy-2-hydroxy-N,N,N-trimethyl-1-propanaminium (also known as carnitine), 2-(acetyloxy)-N,N,N-trimethyl-ethanaminium (also known as acetylcholine), 2-(acetyloxy)-3-carboxy-N,N,N-trimethyl-1-propanaminium, (also known as acetylcarnitine).

The quaternary ammonium salts that do not have an internal counter ion have a negative counter ion X⁽⁻⁾. Examples of such negative counter ions X⁽⁻⁾ are halides, such as chlorine, bromine, fluorine, iodine, and other anions such as hydroxide, carbonate, hydrogen carbonate, nitrate, acetate or formate. Preferred negative counter ions X⁽⁻⁾ are the halides.

Preferred are quaternary ammonium salts that are widely available and that are not expensive. Examples of such quaternary ammonium salts are salts of 2-hydroxy-N,N,N-trimethyl-ethanaminium (also known as choline), 1-carboxy-N,N,N-trimethyl-methanaminium (also known as trimethylglycine), 3-carboxy-2-hydroxy-N,N,N-trimethyl-1-propanaminium (also known as carnitine), salts of N,N,N-tributyl-1-butanaminium (also known as tetrabutylammonium) and salts of benzalkonium, which is a mixture of N-alkyl-N,N-dimethyl-benzenemethanaminium, wherein the alkyl chains have various lengths.

Especially preferred quaternary ammonium salts are salts of 2-hydroxy-N,N,N-trimethyl-ethanaminium (also known as choline), 1-carboxy-N,N,N-trimethyl-methanaminium (also known as trimethylglycine), 3-carboxy-2-hydroxy-N,N,N-trimethyl-1-propanaminium (also known as carnitine) because these are not classified as hazardous material according to Regulation (EC) No. 1272/2008.

At least one quaternary ammonium salt is used as anti-wrinkle agent according to the present invention but also combinations of more than one type of quaternary ammonium salt can be used. The at least one quaternary ammonium salt can also be used in combination with conventional anti-wrinkle agents. Such a combination with a conventional anti-wrinkle agent can be made in any ratio, so effectively from 10 parts of the at least one quaternary ammonium salt combined with 90 parts of conventional anti-wrinkle agent, to 100 parts of the at least one quaternary ammonium salt combined with zero parts of conventional anti-wrinkle agent. It is preferred to have the ratio of the at least one quaternary ammonium salt and the conventional anti-wrinkle agent such that the majority comprises the at least one quaternary ammonium salt, since a larger fraction of the at least one quaternary ammonium salt results in having more of the advantages of the present invention.

To ease the usage of the inventive quaternary amine as anti-wrinkle agent the quaternary amine is generally used as a solution or an emulsion in water, solvents or a combination thereof, wherein also other components may be dissolved, but the quaternary amines can also be used as such, e.g. without dissolving or diluting. Preferably the quaternary amine anti-wrinkle agents are used as an aqueous solution. A lot of water is used in the process of liming, in which the anti-wrinkle agent is used, and therefore the concentration of the quaternary amine in the anti-wrinkle agent composition can be made very low, without having disadvantages. The concentration of the quaternary amine can be as low as 10 weight % on the total amount of the anti-wrinkle agent composition, but preferred are higher concentrations, such as 30 to 80 weight % on the total of the anti-wrinkle agent composition, and more preferred is a concentration of 50 to 70 weight % on the total of the anti-wrinkle agent composition. Optional additional ingredients of the total anti-wrinkle agent composition besides the quaternary amine anti-wrinkle agent of the present invention and optionally other conventional anti-wrinkle agents may comprise surfactants, biocides and/or unhairing agents, such as urea or thiols. The concentration of the optional surfactants and biocides is low, such as up to 2 weight % of surfactants and up to 0.3 weight % of biocides, whereas the concentration of the optional unhairing agent can be large, such as up to 30 weight % on the total of the anti-wrinkle agent composition. An example of a surfactant that can be used to soak hides is trimethylglycine as in CN 101525609 A.

The total amount of anti-wrinkle agent composition for use in the present invention is dependent on the concentration of the quaternary amine in the anti-wrinkle agent composition and on the type of the hides (after fleshing and/or splitting) as the amount and intensity of wrinkles is dependent on the thickness of the hide and also dependent on the animal and its age and size. The total amount of anti-wrinkle agent composition used in the present invention, when using a preferred concentration of quaternary amine in the anti-wrinkle agent composition of 50 to 70 weight %, is similar as is commonly used for traditional anti-wrinkle agent compositions, which is between 0.50% and 2.0%, preferably between 0.60% and 1.20%, wherein the percentages are weight percentages compared to the weight of the hide/pelt. If the concentration of the quaternary amine in the anti-wrinkle agent composition is lower than the indicated preferred 50 to 70 weight % on the total anti-wrinkle agent composition then the amount of the anti-wrinkle agent composition used can be correspondingly increased to arrive at a similar dosage level of the quaternary amine.

Compared with traditional anti-wrinkle agents, the use of anti-wrinkle agents of the present invention is more environmentally friendly. The anti-wrinkle agents of the present invention have the following features: 1) they are safe compounds both to environment and workers; 2) they will not introduce volatile amines and/or volatile thiols into the liming effluent; 3) the anti-wrinkle agents can be easily biodegraded, as evidenced by their high BOD₅/COD ratio, which lowers the environmental footprint of the liming process; while the leather obtained is of similar quality as obtained with traditional anti-wrinkle agents.

COD (chemical oxygen demand) is measured by reacting the oxidizable substance with sulphuric acid and potassium dichromate solution in the presence of silver sulphate as a catalyst. Chloride is masked by mercury sulphate. The value is derived from the intensity of the green coloration of Cr³⁺. The method is according to ISO 15705. A lower COD value, expressed in mg per kg of hide/skin/pelt, is desired. BOD₅ (biological oxygen demand) is the 5-day biochemical oxygen demand, where nitrification is inhibited by 5 mg/L allylthiourea. The dissolved oxygen is analysed in an alkaline solution with a pyrocatechol derivative in the presence of Fe²⁺, under which conditions a red dye is formed which is measured in a photospectrometer. The method is according to EN 1899-1. The ratio BOD₅/COD is calculated from the measured values of COD and BOD₅. A higher BOD₅/COD ratio is seen as better, because this means that the effluent is better biodegradable in a wastewater treatment facility.

### General Description of the Beamhouse Process

### Dehairing

Dehairing is conventionally performed with sulphide and lime (calcium hydroxide). The dehairing treatment is generally carried out in connection with mechanical action, e.g using a paddle, drum, or mixer as mechanical agitation to accelerate the process.

### Liming

The liming step is the conventional final dehairing step in the beamhouse process, which generally uses calcium hydroxide to loosen the collagen structure and to release interfibrillary non-collagenous proteins. The last remnants of hair are removed hereby. For convenience, the present description mentions the use of lime, e.g. calcium hydroxide and calcium oxide, in the liming step, but also other liming agents may be used. Examples of other liming agents are enzymes, as described in ‘Studies on the use of Bi-functional Enzyme for Leather Making’ in Journal of the American Leather Chemists Association, volume 111, 2016, pages 455-460; pseudoalkali metal, alkali metal and alkaline earth metal salts of sugar acids as described in EP 3670675 A1; and a combination of sodium metasilicate with sodium hydroxide, as described in WO 2021/101381.

### Deliming

In the beamhouse process, deliming is performed after the liming process, to remove the liming agent from the pelts and to reduce the pH to 8.5 to 7. The reduction in pH causes the swelling to reverse, which causes an outflow of degraded protein/fat to the float. This is important to prepare the pelt for the remaining part of the beamhouse process.

### Pickling and Tanning

These processes are the remaining steps in the beamhouse process and will not be affected by the modified procedures described above. Some beamhouse processes also include a bating step, which serves to remove additional proteins, this is however an optional step in the beamhouse process of the present invention. The skilled person in the art will know how to conduct these steps.

The liming process using the anti-wrinkle agents of the present invention is exemplified below in detail and generally comprises the following steps, wherein the percentages are the weight percentages compared to the weight of the pelt (pelt being referred to as the hides after fleshing and splitting):

i) Washed skins/hides/pelts are treated in a drum with 30-100% of water together with 0.50-500% of lime and 0.50-2.00% of an anti-wrinkle agent composition comprising a quaternary ammonium salt, for a duration of between 10 and 120 minutes.

ii) Next, unhairing agents and an additional 0.30-2.00% of lime are added to the drum to start the dehairing. The pH has to be monitored and is ideally above 12. After a duration of between 30 and 90 minutes, the hair is optionally filtered from the bath. Next, the drum is run for a duration of between 30 and 240 minutes. Penetration of the lime is checked and when 90-100% of penetration is achieved, the next step is proceeded to. A penetration of 90-100% is meant to achieve a change of pH to below 8 inside 90-100% of the volume of the leather, which can be monitored by using pH-indicators, such as phenolphthalein. The timing for this depends largely on the thickness of the material used.

(iii) An amount of 50-150% of water is added, together with 0.3-2.0% of lime. Next, the drum is run in several cycles of running and resting, and drained afterwards.

Thereafter, using conventional methods, crust is obtained after tanning (preferably Easywhite tanning, which is a tradename from Stahl Europe BV for chrome-free tanning), retanning, neutralization, dyeing and fatliquoring.

The crust or leather obtained by using the process of the present invention is of good quality. The feel of the leather is similar as when a traditional anti-wrinkle agent is used. These properties are visually and tactilely assessed.

The following examples serve to illustrate the invention, but they are not intended to limit it thereto:

### EXAMPLE 1

Dutch cattle hide that has been soaked in the conventional way was used. Percentages are weight percentages compared to the weight of the pelt. The liming process comprised the following steps:

(i) Soaked hide was drummed in a mixture of water of 25° C., 0.03% of a sustainable surfactant mixture (ProSoak; obtainable from Stahl Europe BV), 0.15% of an unhairing enzyme (Bemanol RS-300; obtainable from Stahl Europe BV), 0.15% of sodium sulphide as unhairing agent, and anti-wrinkle agent composition for 20 minutes. The type of anti-wrinkle agent, the amount thereof and the amount of water used is indicated in Table 1 below.

(ii) To the drum was added 0.15% sustainable degreasing agent (ProDegreaze; obtainable from Stahl Europe BV) and 2.00% of lime for immunization. After 15 minutes of running, the drum was rested for 15 minutes.

(iii) Next, 0.85% of sodium hydrosulphide and 0.50% of sodium sulphide was added to start the unhairing. After 45 minutes unhairing was achieved for 95% and the hair was filtered from the bath during 30 minutes. After another 90 minutes of drumming, a mixture was added to the drum consisting of 30% of water, 0.02% of an emulsifier (Eusapon EM; obtainable from Stahl Europe BV) and 0.10% of a wetting agent (Eusapon W; obtainable from Stahl Europe BV). This was run for 30 minutes. Thereafter, the penetration of lime was monitored closely with phenolphthalein, as known to those skilled in the art. As soon as 80% of penetration was achieved the next step was carried out.

(iv) 80% of water was added, together with 1.00% of lime, 0.30% of sodium sulphide as unhairing agent and 0.02% of emulsifying agent (Eusapon EM; obtainable from Stahl Europe BV). The drum was programmed to run for 5 minutes and stop for 25 minutes subsequently, for 9 of those cycles, and drained afterwards.

(v) 100% of water was added to wash the unhaired and limed pelts and they were taken for fleshing and splitting.

Thereafter, using conventional methods, crust was obtained after Easywhite tanning (a tradename from Stahl Europe BV for chrome-free tanning), retanning, neutralization, dyeing and fatliquoring.

Chemical Oxygen Demand (COD) was measured according to ISO 15705. A lower COD value, expressed in mg per kg of skin/pelt, is better. BOD₅ was measured according to EN 1899-1. A higher ratio of BOD₅/COD means that the wastewater is more biodegradable and thus easier to treat. Therefore a high BOD₅/COD can be considered to be more environmentally friendly.

The compositions of the various anti-wrinkling agent compositions in entries 2 to 7 of Table 1 are as follows: a mixture of 50 weight % of the indicated material, together with 20 weight % of urea and 30 weight % of water. Entries 2 and 7 are comparative examples, as ethanolamine is a primary amine that is commonly used as anti-wrinkle agent. The composition of the anti-wrinkling agent composition of entry 8 is as follows: a mixture of 70 weight % of the indicated material and 30 weight % of water.

The benzalkonium chloride, which is used in entry 5, is a mixture of N-alkyl-N,N-dimethyl-benzenemethanaminium chlorides, wherein the alkyl chains have various lengths of between 8 and 18 carbon atoms in each alkyl chain. It was purchased from Sigma-Aldrich.

TABLE 1

| | Anti-wrinkle | % | % antiwrinkle | | |
|---|---|---|---|---|---|
| | agent, | water | agent | BOD₅/ | Leather |
| Entry | a mixture with | soaking | composition | COD | quality |
| 1 | None | 40 | None | 0.28 | Visible |
| (ref) | | | | | wrinkling |
| 2 | Ethanolamine | 40 | 0.80 | 0.25 | Good |
| (comp) | | | | | |
| 3 | Choline chloride | 40 | 0.80 | 0.32 | Good |
| 4 | Tetrabutyl- | 40 | 0.80 | 0.45 | Good |
| | ammonium | | | | |
| | bromide | | | | |
| 5 | Benzalkonium | 40 | 0.80 | 0.32 | Good |
| | chloride | | | | |
| 6 | Choline chloride | 40 | 0.80 | 0.44 | Good |
| 7 | Ethanolamine | 100 | 0.60 | 0.30 | Good |
| (comp) | | | | | |
| 8 | Only Choline | 100 | 0.60 | 0.38 | Good |
| | chloride* | | | | |

The quality of the leather obtained was good after the treatment as described above using the anti-wrinkle agents of the entries 2 to 8, and only when no anti-wrinkle agent was used, in entry 1, the wrinkles were clearly visible in the leather. So, the anti-wrinkle agents based on the inventive quaternary ammonium salts are given the same good performance as the comparative primary amine anti-wrinkle agents of entries 2 and 7. The BOD₅/COD ratio ranged between 0.32 and 0.45 when using anti-wrinkle agents based on the inventive quaternary ammonium salts, whereas the BOD₅/COD was only 0.25 or 0.30 when using comparative primary amine of entries 2 and 7.

1. A process for liming of hides, skins or pelts comprising treating the hides, skins or pelts with an anti-wrinkle agent composition comprising a quaternary ammonium salt.

2. Process according to claim 1, wherein the quaternary ammonium salt is represented by the formula X⁽⁻⁾N⁽⁺⁾R₁R₂R₃R₄ moiety, wherein R₁, R₂, R₃ and R₄ are the same or different alkyl or aryl groups, wherein X⁽⁻⁾ is a negative counterion present when none of R₁, R₂, R₃ and R₄ is an internal counterion.

3. Process according to claim 2, wherein R₁ and R₂ are both alkyl groups having 1 to 4 carbon atoms.

4. Process according to claim 1, wherein the quaternary ammonium salt anti-wrinkle agent is selected from the group consisting of a salt of 2-hydroxy-N,N,N-trimethyl-ethanaminium (choline), 1-carboxy-N,N,N-trimethyl-methanaminium (trimethylglycine), 3-carboxy-2-hydroxy-N,N,N-trimethyl-1-propanaminium (carnitine), a salt of N,N,N-tributyl-1-butanaminium (tetrabutylammonium), a salt of N-alkyl-N,N-dimethyl-benzenemethanaminium, and any mixture thereof.

5. Process according to claim 1, wherein X⁽⁻⁾ is a halide, when the quaternary ammonium salt is not an internal salt.

6. Process according to claim 1, wherein the anti-wrinkle agent composition further comprises another anti-wrinkle agent different from said quaternary ammonium salt.

7. Process according to claim 1, wherein the anti-wrinkle agent composition is an aqueous solution.

8. Process according to claim 1, wherein the quaternary ammonium salt has a concentration between 30 and 80 weight % based on a total weight of anti-wrinkle agent composition as 100%.

9. Process according to claim 1, wherein the total amount of anti-wrinkle agent composition is between 0.50 weight % and 2.0 weight %, based on a weight of the hide, skin or pelt as 100%.

10. Process according to claim 1, wherein the anti-wrinkle composition further contains one or more surfactants, biocides and/or unhairing agents.

11. Process according to claim 1, comprising:
i) treating washed skins, hides or pelts in a drum with a solution comprising 30-100% of water together with 0.50-500% of lime and 0.50-2.00% of an anti-wrinkle agent composition comprising a quaternary ammonium salt for a duration of between 10 and 120 minutes;
ii) adding unhairing agents and an additional 0.30-2.00% of lime to the solution and dehairing at a pH maintained above 12 for a duration of between 30 and 90 minutes;
iii) running the drum for a duration of between 30 and 240 minutes to achieve 90-100% penetration of the lime as determined by a change of pH to below 8 inside 90-100% of the volume of the skin, hide or pelt;
(iv) adding 50-150% of water together with 0.3-2.0% of lime and performing several cycles of running the drum and resting, followed by draining the drum.

12. A limed hides, skins or pelts obtainable by the process according to claim 1.

13. Process according to claim 2, wherein said alkyl or aryl groups contains 1 to 18 carbon atoms.

14. Process according to claim 2, wherein said alkyl or aryl groups are functionalized with one or more hydroxyl, carboxyl, or halide groups.

15. Process according to claim 3, wherein R₁ and R₂ are independently selected from the group consisting of methyl groups and butyl groups.

16. Process according to claim 9, wherein the total amount of anti-wrinkle agent composition is between 0.60% and 1.20% based on a weight of the hide/pelt as 100%.

17. Process according to claim 10, wherein the unhairing agent is urea or a thiol compound.

18. Process according to claim 11, wherein ii) comprises filtering hair from the solution.

19. Process according to claim 11, wherein iii) comprises use of phenolphthalein as pH indicator.
